(19) United States
(12) Patent Application Publication
(10) Pub. No.: US 2010/0221486 A1
(43) Pub. Date: Sep. 2, 2010

(54) BIOCIDAL COMPOSITION, AND RESIN COMPOSITIONS, COMPOSITE MATERIALS, AND LAMINATES CONTAINING THE SAME

(75) Inventors: Kurt Nonninger, Ense (DE); Herbert Klein, Arnsberg (DE)

Correspondence Address: WOLF GREENFIELD & SACKS, P.C., 600 ATLANTIC AVENUE, BOSTON, MA, 02210-2206, US

(73) Assignee: PFLEIDERER HOLZWERKSTOFFE GMBH & CO.KG, Neumarkt (DE)

(21) Appl. No.: 12/598,350

(22) PCT Filed: Mar. 3, 2008
(86) PCT No.: PCT/EP08/52557

§ 371 Date: May 14, 2010

(30) Foreign Application Priority Data
Apr. 30, 2007 (DE) 10 2007 020 390.1

(51) Int. Cl. B32B 5/12; C09D 5/16; B32B 27/06; B32B 21/08; B32B 29/00

(52) U.S. Cl. 428/106; 523/122; 428/702; 428/697; 428/537.1; 428/537.5

(57) ABSTRACT

The invention relates to a biocidal composition comprising at least one nanoscale metal oxide of the transition elements and at least one organic biocidal compound. The invention further relates to a resin composition comprising at least one aminoplast and a biocidal composition according to the invention. The invention also relates to composite materials and laminates containing the disclosed biocidal composition or the disclosed resin composition such that the surfaces thereof have biocidal properties.

The present invention relates to a biocidal composition comprising at least one nanoscale metal oxide of the transition elements and at least one organic biocidal compound. The present invention further relates to a resin composition comprising at least one aminoplast resin and a biocidal composition according to the invention.

Finally, the invention relates to composite materials and laminates containing the biocidal composition according to the invention or the resin composition according to the invention such that the surfaces thereof have biocidal properties.

Biocidal compositions are used in many areas in order to combat e.g. bacteria, fungi, algae etc. In addition to temporary use in the form of solid or liquid compositions which are used, as required, individually or regularly in order to eliminate biological material, it is known to provide a permanent biocidal environment, in particular on the surfaces of materials, by biocidal media being added to the materials. Due to the biocidal active agents present in the vicinity of the surface and, if applicable, the slow diffusion of the latter from deeper layers of the materials, a biocidal effect is achieved continuously over a long period of time.

Surfaces and materials with which biocidal long-term effects are desired are in particular materials which come into contact with food, and materials which are used in environments with high exposure to germs. Examples of this are work surfaces in private and commercial kitchens, pantries, sales counters, table surfaces, floors, shower and changing cubicles, general surfaces in hospital environments and swimming and bathing establishment facilities.

In order for a biocidal composition to be able to retain its biocidal properties stably over a long period of time, it is necessary for the biocidal effect to not be affected in the long term by environmental influences, in particular the effect of heat. Moreover, the germ-reducing effect of the composition in the material containing the latter must exceed a specific minimum level in order for one to be able to speak of a biocidal effect which is sufficient in practice. With regard to this, a reduction in the number of germs after 24 hours, determined by means of a standardised method as described, e.g. in HS Z 2801, by at least two powers of ten, can be considered to be a limit value. In practice, a reduction by at least three powers of ten is preferred.

In the prior art a plurality of compounds and compound classes are known as organic biocidal media. Examples of this are isothiazolinone derivatives, phenol derivatives, various bromic acid derivatives, formaldehyde and derivatives of the latter, guanidines, compounds containing chlorine and/or bromine, urea derivatives etc. However, these organic biocidal compounds do not have sufficient heat resistance, i.e. they are broken down more or less quickly by the effect of heat dependently upon the temperature reached, and so a long-term effect with sufficient strength can not be achieved.

Furthermore, inorganic compounds are known which have biocidal properties such as e.g. borates, glass particles endowed with silver and zeolites endowed with silver. Ointments containing ZnO have been used for a long time for the treatment of cuts.

Temperature stability can be achieved with glass particles or zeolites endowed with silver, but the latter are very expensive. Moreover, the use of these media in high pressure laminate boards (HPL), which are produced by processing in HPL presses, causes damage to the pressing tools of the HPL presses produced from hard-chrome plated steel or brass plate. For these types of product the addition of glass particles or zeolites endowed with silver is therefore often unsuitable.

Metal oxides, such as for example ZnO, MgO, SnO, TiO₂, are contained in finely distributed form in sun protection media as radiation-absorbing agents. Up until now a possible biocidal effect was not the focus of interest. If a biocidal effect was known, such as for example that of ZnO, this was in any case insufficient in order to achieve biocidal properties of solid surfaces as illustrated above, i.e. the germ-reducing effect preferred in practice by at least three powers of ten (measured using the method according to JIS Z 2801 specified above) is not achieved.

Therefore, with the known biocidal media it has not been possible until now to provide an object in this way with biocidal properties on its surface which is also constant over a long period of time if the surface is subjected to increased temperatures.

The requirement for these types of biocidal composition is considerable, however. For example, work surfaces in both private and commercial kitchens, table tops, other setting-down surfaces in gastronomy, surfaces onto which strong sunlight falls etc. are repeatedly subjected to increased temperatures. In the field of kitchens this is due in particular to hot pots, pans and other heated work equipment which are set down on these surfaces. Due to this, and also due to strong sunlight shining onto surfaces, in particular those dark in colour, considerable temperatures can be reached. Therefore, providing these surfaces with heat-stable biocidal properties would therefore provide considerably increased life and consequently greater value of the object in question.

Consequently, it is an object according to the invention to provide a biocidal composition or resin composition which is suitable for providing a material with biocidal properties which achieves a level sufficient in practice, and which is also retained when subjected repeatedly to heat.

This object according to the invention is solved by providing a biocidal composition comprising at least one nanoscale metal oxide of the transition elements and at least one organic biocidal compound, and by means of a resin composition comprising at least one aminoplast resin and this type of biocidal composition.

Furthermore, the object according to the invention is solved by providing a composite material comprising a surface structure impregnated with the resin composition specified above. Finally, the object according to the invention is solved by a laminate comprising a carrier material and on at least one part of at least one surface a resin composition and/or a composite material as defined above.

Further and preferred embodiments of the object according to the invention are explained in detail in the following.

The biocidal composition according to the invention comprises at least one nanoscale metal oxide of the transition elements (in the following also referred to in short as “metal oxide”) and at least one organic biocidal compound (in the following also referred to in short as “organic bactericide”).

A series of compounds can be considered as an organic bactericide, such as for example the compound groups already mentioned at the start as well as approved food preservatives. Preferred compounds are the group of isothiazolinones as well as benzyl alcohol, 2,4-dichlorobenzyl alcohol, 2-phenoxyethanol, 2-phenoxyethanolhemiformal, phenylethyl alcohol, 5-bromo-5-nitro-1,3-dioxane, formaldehyde and formaldehyde deposit materials (e.g. N-formals such as N,N′-dimethylol urea, N-methylol urea, dimethylol dimethyl hydantoin, N-methylolchloracetamide and conversion products of allantoin; glycol formals such as ethylene glycol formal and butyl diglycol formal; and benzylformal), dimethylol dimethylhydantoin, glyoxal, glutardialdehyde, sorbic acid and sorbates (e.g. E200, E202, E203), benzoic acid and benzoate (e.g. E210-E213), salicylic acid, p-hydroxybenzoic acid ester (e.g. E214-E219), chloracetamide, N-methylolchloracetamide, phenols (e.g. p-chloro-m-cresol, o-phenylphenol, biphenyl and sodium ortho-phenylphenol), 4,4-dimethyl-1,3-oxazolidine, 1,3,5-hexahydrotriazine derivatives, quarternary ammonium compounds (e.g. N-alkyl-N,N-dimethyl benzyl ammonium chloride and Di-n-decyl dimethyl ammonium chloride), cetylpyridinium chloride, diguanidine, polybiguanide, chlorohexidine, 1,2-dibromo-2,4-dicyanobutane, 3,5-dichloro-4-hydroxybenzaldehyde, ethylene glycol hemiformal, tetra-(hydroxymethyl)-phosphonium salts, dichlorophene, 2,2-dibromo-3-nitrilopropionic acid amide, 3-iodo-2-propynyl-N-butylcarbamate, methyl-N-benzimidazole-2-yl-carbamate, 2-n-octylisothiazoline-3-one, 4,5-dichloro-2-n-octylisothiazoline-3-one, 4,5-trimethylene-2-methylisothiazoline-3 -one, 2,2′-dithio-dibenzoic acid-di-N-methylamide, 2-thiocyanomethylthiobenzothiazole, C-formals (e.g. 2-hydroxymethyl-2-nitro-1,3-propane diol and 2-bromo-2-nitropropane-1,3-diol), methylene bisthiocyanate, lysozyme (E1105), nisine (E324), natamycin (E235), hexamethylenetetramine (E239), dimethyl dicarbonate (E242), nitrites, nitrates (e.g. E251-E252), propionic acid and propionates (e.g. E280-E283), boric acid, sodium tetraborate, sulphur dioxide and sulphites (e.g. E220-E224, E226-E228 and E385) and ethylene disodium methylene diamine tetraacetate.

In one particularly preferred embodiment the biocidal composition according to the invention contains at least one organic bactericide from the group of isothiazolinones, if appropriate together with one or more other biocide(s) as listed above. Preferred isothiazolinone compounds are alkylisothiazolinones (wherein the alkyl group preferably has 1-12, preferably 1-10 and more preferably 1-8 carbon atoms, and is in particular methyl), benzisothiazolinones and chloroisothiazolinones, in particular methylisothiazolinone, benzisothiazolinone and mixtures of the latter. Even more preferred are 2-methylisothiazoline-3-one and 5-chloro-2-methylisothiazolinone, 2-methyl-3-isothiazolinone, 2-isothiazolinone, 2-n-octylisothiazoline-3-one, 1,2-benzisothiazoline-3-one and mixtures of the latter.

The at least one metal oxide can be any metal oxide of the transition elements provided that it shows biocidal effects, and are preferably ZnO, BaTiO₃, SrTiO₃, TiO₂, WO₃, SnO₂, Al₂O₃, CuO, NiO, ZrO₂, MgO. Particularly preferred are colourless metal oxides such as for example ZnO.

The metal oxide is present in nanoscale form. “Nanoscale” means here that the average particle size of the metal oxide is preferably no more than 1000 nm, in particular 1-1000 nm, more preferably 5-500 nm, even more preferably 10-250 nm, and particularly preferably 20-100 nm.

The average particle size is determined as follows according to the invention. Using a defined sample the surface area of the sample is first of all determined by means of a BET (Brunauer-Emmet-Teller) method by means of the surface adsorption of N₂ at −196° C. according to the method described in DIN 66131. From the intrinsic density of the material being investigated and the mass (the weight) of the sample the volume of all of the particles is determined. Based on the assumption that the particles (a) do not have any pores and consequently have a “smooth” surface, (b) are spherical, and (c) are subjected to the test gas over their whole outer surface, from the ratio of the volume to the surface area of all of the particles the average particle diameter is determined which is specified here as the average particle size.

According to one particularly preferred embodiment the biocidal composition according to the invention comprises at least one isothiazolinone derivative and nanoscale zinc oxide. Further preferred isothiazolinone derivatives are the further preferred benzisothiazolinone derivatives specified above and mixtures of the latter.

The mix ratio of organic biocide, preferably at least one isothiazolinone derivative, to the metal oxide, preferably zinc oxide, and more preferably nanoscale zinc oxide, preferably comes within a range of from 1:10 to 50:1 in relation to the weight. More preferably this mix ratio comes within the range of from 1:2 to 25:1, even more preferably in the range of from 1:1 to 15:1, and most preferably from 2:1 to 10:1.

The amount of biocidally effective components contained within the composition according to the invention is not particularly restricted. However, it should preferably come within a range which does not make it unnecessarily difficult to achieve a sufficient biocical effect as defined above when being used to produce a resin composition according to the invention and/or a composite material/laminate according to the invention. Therefore, the biocidal active agent content comes preferably within the range of from 10-100% by weight, more preferably 20-90% by weight, more preferably 40-80% by weight.

The resin composition according to the invention comprises the biocidal composition according to the invention and at least one aminoplast resin. Although the present invention can be applied to the whole diversity of aminoplast resins, known in the prior art, the preferred aminoplast resins are melamine resins. Melamine resins are widely used in industry, for example for coatings for surfaces or for the production of decorative laminates. Of particular technical significance among the available melamine resins are melamine formaldehyde and melamine/urea formaldehyde resins which are also preferred according to the invention. Due to their outstanding properties such as, for example, scratch resistance, flame-retarding properties, chemical and mechanical resistance and mechanical harness, they are particularly suitable for objects subjected to high levels of stress, in particular for surfaces in daily use. For example, melamine resins, and in particular the preferred melamine resins, are used for floors and furniture surfaces. By means of the resin composition according to the invention, an aminoplast resin provided particularly advantageously with biocidal properties is provided which retains its biocidal properties over a long period of time, even if it is subjected repeatedly to increased temperatures.

The resin composition according to the invention can be produced by an aminoplast resin provided in dissolved form being mixed with the biocidal composition according to the invention using conventional mixing apparatuses, such as for example agitators. The mixing is implemented here in such a way that the mix of biocidal composition and aminoplast resin is stirred so thoroughly that the most uniform possible distribution of the biocidal composition is obtained in the aminoplast resin suspension in which the particles are kept permanently in suspension.

The aminoplast resin in the composition according to the invention can be a cured aminoplast resin, but is preferably a resin precondensate which in a later step, such as for example a step of compressing a surface structure impregnated with composition according to the invention with a carrier material under pressure and at increased temperature.

Normally the aminoplast resin into which the biocidal composition is mixed is provided as an aqueous or alcoholic solution. The biocidal composition can be added to the aminoplast resin in solid and/or liquid form (e.g. as a solution of the organic biocide in a solvent and metal oxide particles suspended therein).

The biocidal aminoplast resin suspension which is obtained by the procedure described above can then be further processed directly afterwards, e.g. in order to produce a laminate by impregnating a surface structure with the composition, or can be transformed into a solid resin composition, e.g. by spray drying, and be further processed at a later point in time.

It is also possible to mix in the biocidal composition at the time of the aminoplast resin synthesis. Here the resin precondensate produced during the aminoplast resin synthesis is preferably cooled down and then mixed with the biocidal composition. It is advantageous here that an aminoplast resin composition provided with biocidal properties can be produced directly from the raw materials for the aminoplast synthesis without any additional intermediate step of isolating the aminoplast resin.

If the biocidal composition is mixed into the aminoplast resin after the resin synthesis, it is mixed into a solution of the aminoplast resin in an appropriate solvent. If the aminoplast resin has been transformed into a solid form after its synthesis, as described above, it is preferably transformed into a dissolved form before adding the biocidal composition.

The composite material according to the invention comprises a surface structure impregnated with the resin composition according to the invention. This is produced by a surface structure, which is capable of receiving a resin composition according to the invention, being treated with a liquid form of the resin composition according to the invention, i.e. a solution or suspension, and then excess solvent is removed. Dry, absorbent materials such as for example paper, cardboard, woven fabric or fleece, wood veneer, wood fibreboards or wood chipboards are preferred as a surface structure to be impregnated. Particularly preferred are paper, cardboard and textile materials such as woven fabrics or fleeces, and particularly preferred is paper, in particular decorative paper or overlay paper.

The resin composition used to produce this composite material preferably contains in addition to the aminoplast resin described and the biocidal composition according to the invention a solvent, in particular water and/or an alcohol (e.g. methanol, ethanol, propanol, buthanol) and can contain further additives, as commonly used in the field of the present aminoplast resin composites. Examples of these types of additive are fillers, colourants, pigments, antioxidants, UV stabilisers, wetting agents, separating agents, softeners, hardeners and cross-linking agents.

Moreover, the resin composition according to the invention can contain corundums as a further additive. The latter bring about an increase in the abrasion resistance of the composite materials according to the invention. Due to this the composite materials according to the invention are suitable, e.g. in the form of overlay papers containing corundum, for producing laminates which are used to produce floors and other surfaces subjected to high levels of mechanical stress.

These additives can already be contained in the biocidal composition according to the invention, they can be contained in the aminoplast resin component or be added separately to the impregnating composition. Likewise, two or more of these adding methods can be combined with one another, and all desired additives can be introduced independently of one another in any of the ways suggested.

The quantity of resin composition according to the invention applied to the surface structure is normally 20-300 g/m², preferably 50-150 g/m², more preferably 90-110 g/m² of the impregnated surface in relation to the weight of the impregnated resin composition after drying.

In a further embodiment patterns with non-treated aminoplast resin are pre-impregnated. (Aminoplast resin=UF, triazine F, mixtures of the latter or resins which are condensed together from triazines, urea and formaldehyde). The degrees of resin impregnation of the pre-impregnates are then approx. 40-120%, preferably 60-100%, more preferably 80-90%, in relation to the weight of the surface structure not impregnated with resin. In a further step resin compositions according to the invention are then applied to these pre-dried strips in a quantity of 5-60 g/m², preferably 15-35 g/m², in relation to solid resin according to the invention.

The resin composition according to the invention containing solvent used for the impregnation preferably has a solids content of 20-80% by weight, preferably 30-70% by weight, more preferably 40-60% by weight, and even more preferably 45-55% by weight.

If the surface structure impregnated with the resin composition according to the invention is a paper or a textile, the quantity applied to the resin composition according to the invention, in relation to the surface structure before impregnation, is normally 40-400% by weight, preferably 70-150% by weight, more preferably 90-130% by weight. If an overlay paper is used, the amount of resin applied to the overlay comes typically within the range of 200-350% solid resin in relation to the weight of the paper. Here it is only the overlay, but not the dry decorative paper impregnated with resin, unprinted or printed, which is provided with the resin composition.

As already described, the impregnated surface structure is dried after impregnation, and can then, if appropriate, be compressed with one or more further surface structures to form a laminate. Since the aminoplast resin is preferably present in the resin composition according to the invention as an aminoplast resin precondensate, when producing the laminate by compression at increased pressure and increased temperature, total curing of the resin composition according to the invention takes place.

Preferred laminates according to the invention comprise on the one hand directly coated products with which a composite material, which is a paper or textile impregnated with the resin composition according to the invention, preferably a decorative paper or an overlay paper, is laminated directly onto a carrier material, such as for example MDF boards, chipboards or plywood boards.

Instead of just one decorative film laminated onto the carrier material, a number of identical or different decorative films can of course also be laminated directly onto the carrier material.

According to a further embodiment the laminate according to the invention includes one or more layers of decorative film which are compressed with soda kraft papers containing binding agents or recycled paper. Binding agents suitable for such soda kraft papers containing binding agents are for example phenol resins, phenol aminoplast resin mixtures or cocondensates. In this way products called high pressure laminate boards are obtained which are generally 0.2-2 mm thick. These types of laminate with a thickness of 0.2-0.4 mm are called thin laminates, and those with a thickness of 0.4-2 mm, preferably 0.5-1.5 mm are called thick laminates. These laminates can be smoothed on their rear side after production and then be adhesively bonded onto carrier materials. The smoothing process can also be dispensed with if appropriate materials have been compressed onto the rear side of the laminate (for example: vulcament or vulcan fibre) or adhesive types which do not require rear side smoothing (for example: polyurethane adhesive, epoxide resin adhesive, polyester adhesives) are used to stick onto carrier materials.

According to a further embodiment the HPL materials can be produced with a thickness of 1-40 mm, preferably 2-30 mm. Preferably these types of material are provided on both sides, as (an) outer layer(s), with one or more layers of decorative film which are laminated onto the soda kraft paper containing binding agents. They are preferably used in non-adhesively bonded form as self-supporting products, for example for shower and changing cubicle partitions, for table tops or bumper strips for hospital passageways.

The biocidal composition according to the invention or the resin compositions, composite materials and laminates which contain the latter have an excellent biocidal effect which is not substantially affected either when subjected to heat. In the following this effect is described by means of several examples and comparative examples.

### EXAMPLES

In the following examples the biocidal effect of surfaces was tested according to JISZ 2801. Here the tests were carried out with four different test germs at an incubation temperature of 36±2° C. The test method serves to determine the biocidal, in particular antimicrobial effect of a surface. For this purpose the test specimens to be investigated were coated with a defined number of germs in a suitable culture medium (e.g. CASO Agar; Heipha Diagnostika GmbH, D-69214 Eppelheim) and analysed after 24 hours. For this purpose test specimens coated with aminoplast resin were produced in the way described below and analysed after 0 and 24 hours. Test specimens coated with aminoplast resin and which contained no biocidal composition were used as a reference.

Testing of the biocidal effect was carried out with the following organisms:

| | | |
|---|---|---|
| Pseudomonoas aeruginoa | ATCC 15442 | 2.6 × 10⁵ KBE/test surface |
| Staphylococcus aureus | ATCC 6538 | 2.8 × 10⁵ KBE/test surface |
| Salmonella chloeraesius | ATCC 9898 | 2.2 × 10⁵ KBE/test surface |
| Escherichia coli | ATCC 8739 | 2.7 × 10⁵ KBE/test surface |

An assessment of the biocidal effect was made using the following categories:

Reduction by a factor X after 24 hours:

| | |
|---|---|
| X < 10¹ | no significant biocidal effect |
| 10¹ ≦ X < 10² | small biocidal effect |
| 10² ≦ X < 10³ | significant biocidal effect |
| 10³ ≦ X | strong biocidal effect |

Production of Biocidal Compositions

Modification Agents M-1

In a stirring container 6.27 kg of a 20%, aqueous benzisothiazolinone solution; 2.08 kg of a 20% aqueous methylisothiazolinone; 4.84 kg of an aqueous 50% aqueous formaldehyde solution are stirred into a provided quantity of 4.294 kg diethylene glycol in the specific sequence. The solution thus obtained is adjusted to pH 5-6 with approx. 0.36 kg of a 15% aqueous amidosulfonic acid. 17.9 kg of a biocidal modification agent is produced.

Production of Resin Compositions

Impregnating Bath, Comparison (IV-1)

1000 kg of a microdispersion of melamine resin in water (resin content 55% by weight) are displaced with 2.3 kg of a hardener of the sulfonic acid type and the required quantities of conventional wetting agents, separating agents, and if appropriate defoaming agents. Next 17.9 kg of the modification agent M-1 described above are added to the resin bath while stirring, the formaldehyde contained in M-1 being added quickly to the melamine resin matrix. After homogenisation the preparation is ready for further processing.

Impregnating Bath, Comparison (IV-2)

In the same way as with IV-1 an impregnating bath is produced to which after homogenisation 0.920 kg of an aqueous silver complex solution (Ag⁺ concentration: 6% by weight) are additionally added. After a further stirring time of 10 mins the preparation is ready for further processing.

Impregnating Bath, According to the Invention (IE-1)

In the same way as with IV-1 an impregnating bath is produced to which after homogenisation 10 kg of an aqueous 50% by weight suspension of nanoscale ZnO with an average particle size of 40 nm are additionally added. After a further stirring time of 10 minutes the preparation is ready for further processing.

Impregnating Bath, Comparison (IV-3)

1000 kg of a microdispersion of melamine resin in water (resin content 55% by weight) are displaced with 2.3 kg of a hardener of the sulfonic acid type and the required quantities of conventional wetting agents, separating agents and if appropriate defoaming agents. Next 10 kg of an aqueous 50% by weight suspension of nanoscale ZnO with an average particle size of 40 nm are stirred in. After a further stirring time of 10 minutes the preparation is ready for further processing.

The impregnating baths IV-1 to IV-3 and IE-1 produced have the biocidal active agent contents listed in Table 1, respectively in relation to solid aminoplast resin:

TABLE 1

| | Impregnating bath | | | |
|---|---|---|---|---|
| Biocidal active agent | IV-1 | IV-2 | IV-3 | IE-1 |
| Benzisothiazolinone (% by weight) | 0.27 | 0.27 | — | 0.27 |
| Methylisothiazolinone (% by weight) | 0.09 | 0.09 | — | 0.09 |
| Formaldehyde (% by weight) | 0.51 | 0.51 | — | 0.51 |
| Nanoscale ZnO (% by weight) | — | — | 0.9 | 0.9 |
| Ag+ (ppm) | — | 100 | — | — |

Production of Composite Materials/Laminates

With the impregnating baths IV-1 to IV-3, IE-1 and a further comparison bath IV-4 (like impregnating bath IV-1, but without biocidal active agents) resin-coated decorative papers were produced by decorative papers of overlay being impregnated with the respective baths and being dried at 130° C. The basic weights of the paper, resin coating quantities and ratios and the residual contents of volatile components after drying are shown in Table 2.

TABLE 2

| | | Decorative | Resin | |
|---|---|---|---|---|
| | | paper | application | Vol. |
| Test | Bath | (weight)¹⁾ | (% by weight)¹⁾ | components²⁾ % |
| Comparison (V1) | IV-1 | 100 | 120/120 | 5.9 |
| Comparison (V2) | IV-2 | 28 | 79.8/285 | 6.4 |
| Comparison (V3) | IV-3 | 28 | 79.8/285 | 6.5 |
| Comparison (V4) | IV-4 | 28 | 79.8/285 | 6.5 |
| Invention (E1) | IE-1 | 118 | 106.2/90 | 5.5 |

¹⁾Weight in g/m², % in relation to the paper weight (atro)
²⁾Residue of volatile components after drying

The impregnates produced in this way were compressed using conventional procedures onto 3 commercially available core layers for HPL, by means of which composite materials/laminates were obtained. These were investigated in the way described above with regard to the biocidal effect of their surface. The investigation took place either directly after production or after ageing (storage for a specific time at a specific temperature and air humidity) and after exposure to an increased temperature over a specific period of time. The conditions and results are specified in Table 3.

As the results show, the composite materials/laminates according to the invention have an excellent biocidal effect which also remains practically unchanged by the effect of a high temperature over a longer period of time. Therefore the biocidal effect of the materials according to the invention are unexpectedly improved with respect to the prior art.

TABLE 3
Test Biocide in the solid resin Ageing Germ
reductions (powers of ten)

| | MIT % by | BIT % by | FO % by | ZnO % by | Ag⁺ | | | temp. | Pseudonomas | Staphyloc. | Salmonella | |
|---|---|---|---|---|---|---|---|---|---|---|---|---|
| | weight | weight | weight | weight | ppm | time | | (° C.) | aeroginosa | aureus | Choleraesius | E. Coli |
| V4 | — | — | — | — | — | 20 | mins | 180 | 0 | 0.69 | 0.83 | 0 |
| V1-a | 0.09 | 0.27 | 0.5 | — | — | 14 | days | 20 | >4.1 | 2.5 | 3.2 | 3.0 |
| V1-b | 0.09 | 0.27 | 0.5 | — | — | 14 | days | 40 | 2.1 | 2.1 | 2.6 | 0.3 |
| V1-c | 0.09 | 0.27 | 0.5 | — | — | 14 | days | 80 | 0.6 | 2.0 | 1.0 | −0.2 |
| V1-d | 0.09 | 0.27 | 0.5 | — | — | 20 | mins | 180 | 0.3 | 1.1 | 1.2 | 0.1 |
| V2-a | 0.09 | 0.27 | 0.5 | — | 100 | — | | — | >4.4 | 2.2 | 1.7 | 0.2 |
| V2-b | 0.09 | 0.27 | 0.5 | — | 100 | 20 | mins | 180 | 0.8 | 0.6 | 1.3 | 0.0 |
| E1-a | 0.09 | 0.27 | 0.5 | 0.9 | — | — | | — | >4.4 | >4.4 | >4.3 | >4.4 |
| E1-b | 0.09 | 0.27 | 0.5 | 0.9 | — | 20 | mins | 180 | >4.4 | >4.4 | >4.3 | >4.4 |
| V3 | — | — | — | 0.9 | | 20 | mins | 180 | 0.11 | 0.35 | 0.48 | 0 |

1. A biocidal composition comprising an inorganic biocide and at least one organic biocidal compound, wherein the inorganic biocide consists of at least one nanoscale metal oxide selected ZnO, BaTiO₃, SrTiO₃, TiO₂, WO₃, Al₂O₃, CuO, NiO, ZrO₂ and MgO.

2. The biocidal composition of claim 1, wherein the at least one nanoscale metal oxide comprises ZnO.

3. The biocidal composition of claim 1, wherein the at least one nanoscale metal oxide has an average particle size of 1-1,000 nm, preferably 5-500 nm, more preferably 10-250 nm, and even more preferably 20-100 nm.

4-6. (canceled)

7. The biocidal composition of claim 1, wherein the at least one organic biocidal compound comprises at least one isothiazolinone derivative.

8. The biocidal composition of claim 7, wherein the at least one isothiazolinone derivative is selected from benzylisothiazolinones, methylisothiazolinones, chloroisothiazolinones, chloromethylisothiazolinones and mixtures thereof.

9-10. (canceled)

11. The biocidal composition of claim 1, wherein the mixing ratio of the at least one organic biocidal compound to nanoscale metal oxide, based on wt.-%, is in the range of 1:10 to 50:1, preferably in the range 1:2 to 25:1, more preferably in the range 1:1 to 15:1, and even more preferably in the range 2:1 to 10:1.

12-14. (canceled)

15. A resin composition which comprises at least one aminoplast resin and a biocidal composition, wherein the biocidal composition consists of the biocidal composition of claim 1.

16. The resin composition of claim 15, wherein the biocidal composition is present in an amount, based on the total solids content of the resin composition, of 0.1-8 wt.-%, preferably 0.5-5 wt.-%, and more preferably 1-3 wt.-%.

17-18. (canceled)

19. The resin composition of claim 1, wherein at least one isothiazolinone derivative and the nanoscale metal oxide are present in amounts of 0.1-0.5 wt.-% and 0.5-4 wt.-%, respectively, based on the total solids content of the resin composition, preferably in amounts of 0.2-0.4 wt.-% and 1-3 wt.-%, respectively.

20. (canceled)

21. The resin composition of claim 15, which further comprises at least one of the following selected from fillers, colourants, pigments, antioxidants, UV stabilisers, wetting agents, separating agents, softeners, hardeners and cross-linking agents.

22. The resin composition of claim 21 which comprises at least one corundum composition as a filler.

23. The resin composition of claim 15 which further comprises a solvent for the at least one melamine resin and is present in the form of a solution, dispersion or suspension.

24. The resin composition of claim 23, wherein the solvent is selected from water, solvents mixable with water, and any mixtures thereof.

25. The resin composition of claim 24, wherein the solvent mixable with water is selected from water-soluble alcohols, ketones, glycols and glycol ethers.

26. (canceled)

27. The resin composition of claim 23 which has a solids content of 20-80 wt.-%, preferably 30-70 wt.-%, more preferably 40-60 wt.-%, and even more preferably 45-55 wt.-%.

28-30. (canceled)

31. The resin composition of claim 15, wherein the aminoplast resin is a melamine resin.

32. A composite material which comprises a surface structure impregnated with a resin composition of claim 15.

33. The composite material of claim 32, wherein the surface structure impregnated with the resin composition is selected from a paper, a decorative paper, an overlay, a textile and a fleece.

34. (canceled)

35. A laminate which comprises a carrier material and on at least part of at least one surface a resin composition of claim 15.

36. A laminate which comprises at least one layer of at least one composite material of claim 32 on a carrier material.

37. The laminate of claim 36, wherein the carrier material is selected from MDF boards, chipboards and plywood boards.

38. A laminate which comprises one or more layers of a composite material of claim 33 and a carrier selected from sodium kraft paper containing binding agents and recycled paper containing binding agents.

39. A method comprising
producing surfaces with a composite material of claim 32, wherein the surfaces comprise thermostable biocidal properties.

40. The method of claim 39 wherein the surfaces are selected from work surfaces for kitchens, laboratories, hospitals, caravans, hotels and guesthouses; surfaces for floors, doors, conservatories, lifts, discotheques, wet rooms, internal fittings in means of transport, partition walls and trade show structures.
